(19) United States
(12) Patent Application Publication
(10) Pub. No.: US 2010/0310696 A1
(43) Pub. Date: Dec. 9, 2010

(54) Pre-loading mechanism for a tilting platen in a thermoforming press

(76) Inventor: Brian D. Schlepp, Yakima, WA (US)

Correspondence Address: Svendsen Legal, LLC, P.O. Box 10627, Yakima, WA, 98909, US

(21) Appl. No.: 12/455,815

(22) Filed: Jun. 5, 2009

(51) Int. Cl. B29C 51/20; B28B 3/00

(52) U.S. Cl. 425/161; 425/408

(57) ABSTRACT

A tilting platen pre-loading system for thermoforming press the system pre-loads a tilting thermoforming press platen with a specialized spring-loaded hammer and anvil assembly, to provide better efficiency and consistency in the high speed, cyclic operation of the thermoforming press. The anvil assembly includes an anvil base and an anvil, and the anvil base is immovably mounted to a tilt-frame. The anvil is maintained separate from the anvil base by a loading spring, which are preferably conical or Belleville washers. The tilting platen is rotatably mounted within the tilt-frame and a platen hammer immovably mounts to the tilt-frame. The loading spring compresses and retracts the anvil as the hammer contacts the anvil, and the tilting platen rotates on the tilt-frame to align the tilting platen with a receiving platen. The loading spring de-compresses and extends the anvil as the hammer separates from the anvil, and the tilting platen rotates on the tilt-frame away from the over-platen.

### TECHNICAL FIELD

The invention relates to a tilting platen pre-loading system for thermoforming press. More particularly, the invention relates to a mechanism of pre-loading a tilting thermoforming press platen with a specialized spring-loaded hammer and anvil system, to provide better efficiency and consistency in the high speed, cyclic operation of the thermoforming press.

### BACKGROUND OF THE INVENTION

The continuous sheet thermoforming of synthetic plastic articles is a widely utilized industrial process. Thermoformers can take a variety of configurations, but each type includes the same basic stations. The plastic raw material is utilized in rolls or precut sheets. Common thermoformers include rotary machines, single stage devices, or as preferred for the purposes of the present invention, an in-line, continuous sheet thermoformer.

At the feed end of the in-line thermoforming process, a thin sheet of plastic is positioned at an in-feed or loading station. The loading station may receive the plastic sheet directly from an extruder, or from a rolled sheet of material. The thin plastic sheet is fed continuously, from the loading station to a heating station and then to a forming station. At the heating station the sheet is heated to the required forming temperature. In the forming station the sheet is deformed or molded into the desired shape. This forming is accomplished by direct compression or differential pressure forces, or a combination of these forces to fit the shape of the mold within the former.

For the thermoforming process, the sheet of thermoplastic material is heated until it becomes soft and pliable, but not fluid. The heated sheet is briefly held within the mold of the thermoforming press for forming. Some thermoforming presses rely on a tilting platen to provide additional advantages in speed and operational efficiency. The tilting platen is able to eject the thermoformed product more quickly than non-tilting platens. Higher processing speeds from a tilting patten can only be realized if a high degree of consistency and precision are maintained.

A new system of press operation is needed that minimizes alignment errors and aids in the efficient and high speed operation of the tilting thermoforming press. The present invention addresses these speed limiting problems for tilting platen thermoformers and provides a new system of pre-loading a tilting thermoforming press patten. The aspects and advantages of the invention will become apparent from consideration of the following figures and description.

### BRIEF DESCRIPTION OF DRAWINGS

FIG. 1 is an isometric view of a portion of a thermoforming press with a tilting platen pre-loading system, according to an embodiment of the invention;

FIG. 1A is an isometric view of a portion of a thermoforming press with a tilting platen pre-loading system, which is a detail of area 1A noted in FIG. 1, according to an embodiment of the invention;

FIG. 2 is a front view of a portion of a thermoforming press with a tilting platen pre-loading system, according to an embodiment of the invention;

FIG. 3A is a side view of a portion of a thermoforming press in a clamped position with a tilting platen pre-loading system, according to an embodiment of the invention;

FIG. 3B is a side view of a portion of a thermoforming press in an unclamped position with a tilting platen pre-loading system, according to an embodiment of the invention;

FIG. 4 is a partially sectioned side elevation view of a portion of a tilting platen pre-loading system, according to an embodiment of the invention;

FIG. 4A is a partially sectioned side elevation view of a portion of a tilting platen pre-loading system, which is a detail of area 4A noted in FIG. 4, according to an embodiment of the invention;

FIG. 5 is an isometric view of a portion of a tilting platen pre-loading system, according to an embodiment of the invention; and

FIG. 6 is a side view of a portion of a portion of a tilting platen pre-loading system, according to an embodiment of the invention.

Reference characters included in the above drawings indicate corresponding parts throughout the several view, as discussed herein. The description herein illustrates one preferred embodiment of the invention, in one form, and the description herein is not to be construed as limiting the scope of the invention in any manner. It should be understood that the above listed figures are not necessarily to scale and that the embodiments are sometimes illustrated by fragmentary views, graphic symbols, diagrammatic or schematic representations, and phantom lines. Details that are not necessary for an understanding of the present invention by one skilled in the technology of the invention, or render other details difficult to perceive, may have been omitted.

### DETAILED DESCRIPTION OF SPECIFIC EMBODIMENTS

The present invention includes a pre-loading mechanism for a tilting platen in a thermoforming machine. The tilting platen rotates with each thermoforming cycle, as commonly employed in certain in-line thermoforming process machines. The tilting platen provides for faster and more efficient ejection of the thermoformed product from the platen, as it tilts. Specifically, the pre-loading mechanism of the present invention repeatedly and reliably provides a dampening force to the rotational or tilting thrust of the lower, tilting platen as it “registers” in alignment to its vertical, clamping axis. The pre-loading mechanism employs a preset compressive force or ‘resistance’ provided by a dampening spring element.

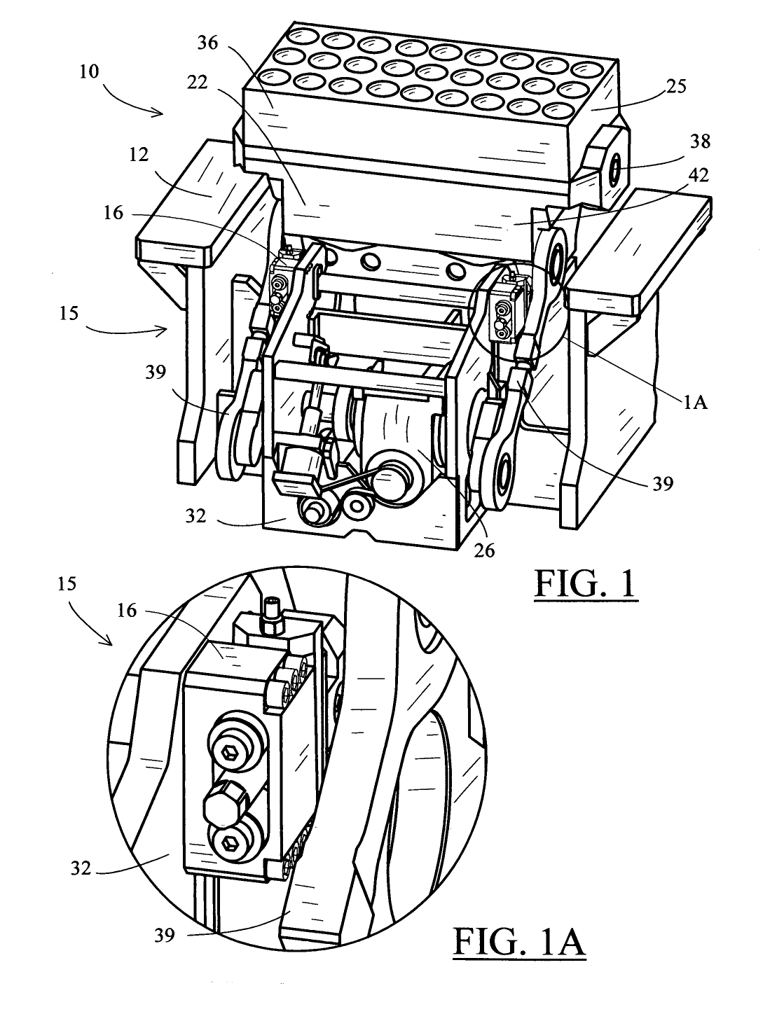

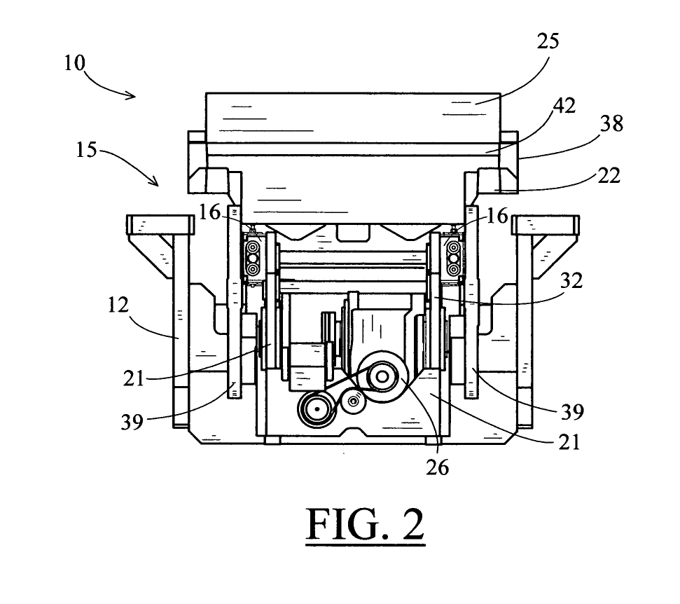

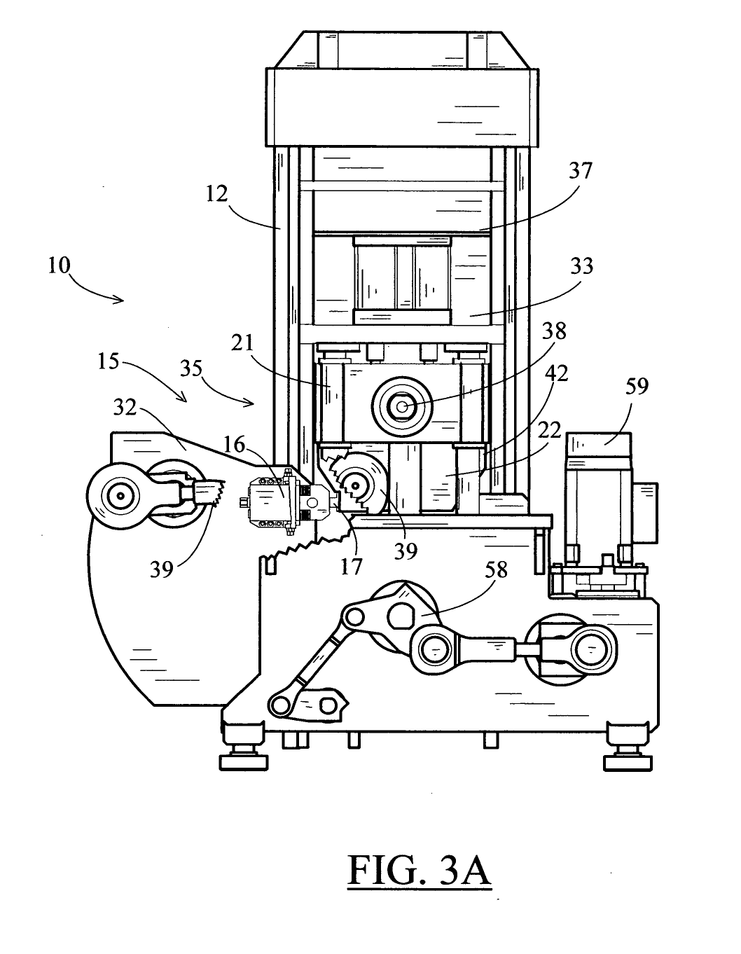

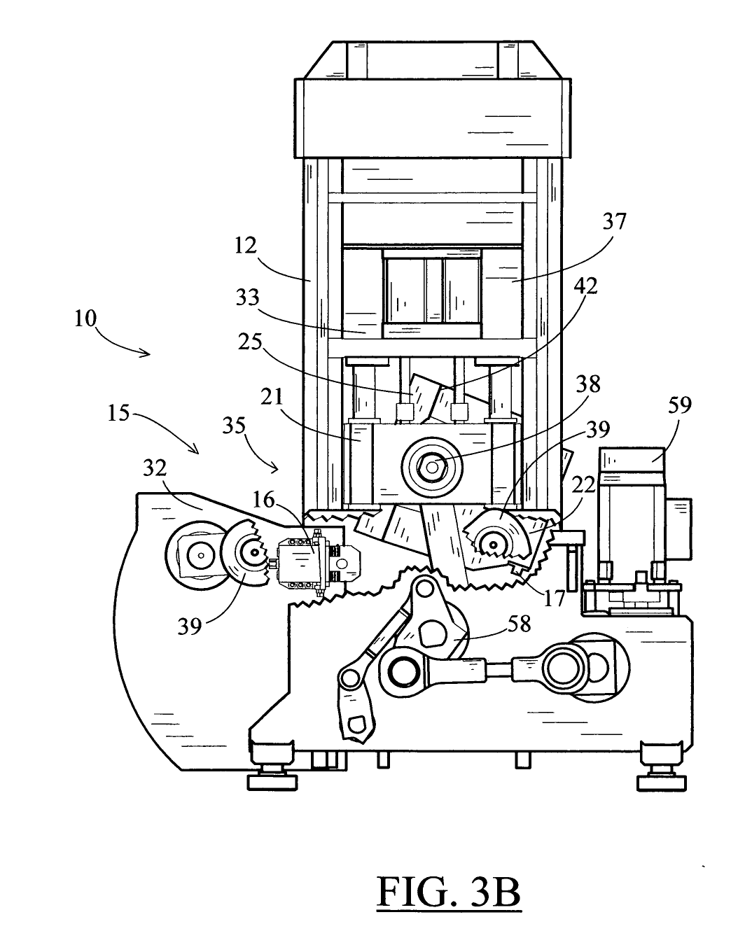

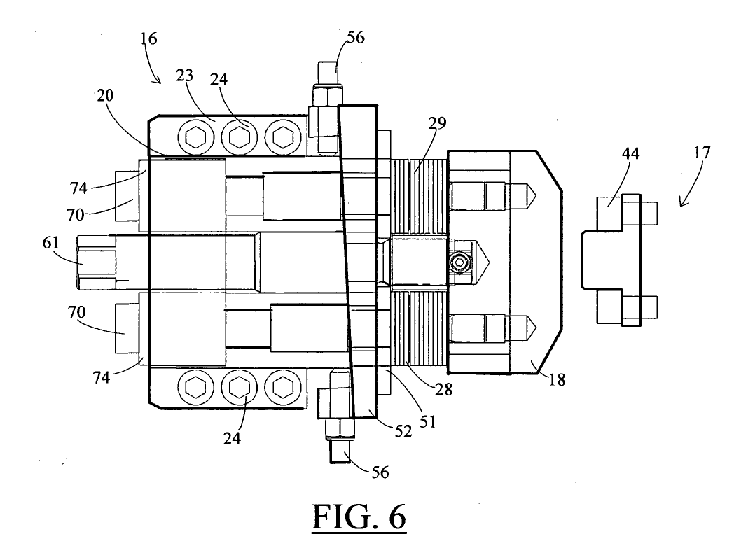

A preferred embodiment of the system of the present invention is shown in FIGS. 1 through 6. The pre-loading mechanism of present invention includes an anvil assembly 16 that is impacted by a platen mounted hammer 17, at each operational stroke of a thermoforming press 10. The thermoforming press, as shown in FIGS. 3A and 3B, may be simply referred to herein as a “press,” and includes an over-frame 12, referred to herein as a “frame.” The frame serves as a static anchor and mount for the moving components of the press. For the present invention, the thermoforming press includes a tilting platen 25. The tilting platen cyclically engages and clamps under high force onto a receiving platen 33, preferably mounted above the tilting platen, as shown in FIG. 3, to thermoform a product from a preheated and continuous sheet of plastic material, at a high cycle rate.

A platen tilt-body 22, or simply the “tilt-body,” is a movable component hinge-ably mounted within the over-frame 12 of the press 10. As preferred, the tilt-body includes the tilting platen 25, actuated by a tilt crank arm 39 turned by a tilt motor 26 . The tilt crank arm rotates the tilt-body and attached tilting platen on each stroke of the press.

For conventional “in-line” or continuous feed thermoforming operations, a high-speed and secure clamping of two platens deforms the continuous plastic sheet into the desired product. The platens are preferably utilized in pairs, with one platen contacting a pre-heated sheet of plastic material from one side, while the second platen contacts the sheet from the other side. The two platens reciprocate in unison to contact and form the thermoformed article product, which may be a plurality of articles, from the continuous sheet of thermoplastic material. With tilting platen presses, one of the two platens includes a tilting motion after un-clamping, to facilitate ejection of the thermoformed product from the platen.

For a preferred embodiment of the thermoforming press 10 equipped with the pre-loading mechanism 15 of the present invention, the tilting platen 25 mounts to the platen tilt-body 22 at a tilt platen mount 36 on the tilt body. Similarly, the receiving platen 33 mounts to a receiving platen mount 37 within the over-frame 12. For tilting platen thermoformers, the receiving platen is typically positioned above the tilting platen, as shown in FIGS. 3A and 3B. The platen tilt-body hinges within a tilt frame 21, where it is forced to pivot about a tilt pivot 38 by the action of the tilt crank arm 39.

The tilt frame 21 moves up and down, linearly, within the over-frame 12, to place the tilting platen 25 against the receiving platen 33. The linear, clamping action of the tilt frame is achieved by the actuation of a clamping crank 58, which is rotated by a clamp motor 59, shown in FIGS. 3A and 3B. When the tilt frame is at its lowest position within the over-frame, the tilt-body 22 with the attached hammer 17, is then in position to rotate away from the anvil assembly 16, mounted to a carriage 32, as detailed in FIG. 3B.

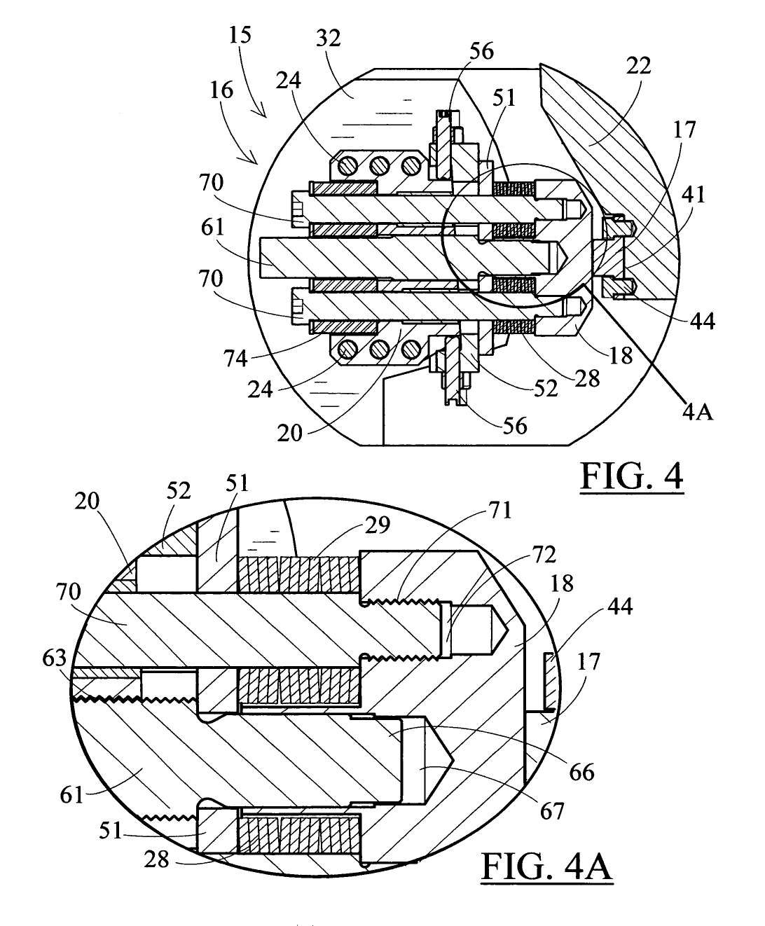

As shown in FIGS. 4, 4A, 5 and 6, a preferred pre-loading mechanism 15 includes the anvil assembly 16, simply referred to herein as the “anvil” 16, placed in opposition to the platen hammer, simply referred to herein as the “hammer” 17. The hammer strikes an anvil head 18, of the associated anvil assembly that also includes an anvil base 20, which receives the anvil head. The anvil base, anvil head and hammer are each preferably milled from a solid metal block, and the anvil head and hammer are most preferably milled from metal alloys chosen for high strength, such as “Al—Mg—Li alloy 01420.” The anvil base is immovably mounted to the carriage 32. The anvil base includes anvil feet 23, for solid attachment to the carriage with a set of anvil bolts 24. The carriage acts as an anchor for the anvil assembly. The carriage has the ability to absorb the force of the impacting hammer, without resultant movement in the direction of the impact.

The anvil head 18 is maintained separate from the anvil base 20 by compressive tension provided by a loading spring 28, as shown in FIG. 4. The loading spring is contained between the anvil and the anvil base, to absorb force applied to the anvil by the hammer 17. The loading spring is preferably a stack of conical, or spring-washers 29, placed in series, as shown in FIG. 4A.

A most preferred spring-washers 29 of the loading spring 28 can be referred to as “Belleville” type washers, and are also known as “conical” or “cupped spring-washers.” Spring-washers are a well-known mechanical dampening device, with many uses. With its conical shape, the spring-washers efficiently provide a mechanical, resistance to being flattened under compression. Belleville washers must be properly engineered to provide the needed resistance to flattening or “deflection.” Multiple Belleville washers may be stacked to modify the linear amount of deflection, along with the force required to deflect the spring-washer, termed herein as “rebound force.”

The loading spring 28 may be a single spring-washer 29, or as preferred, a plurality of spring-washers, oriented in parallel or in series, to increase the rebound force and the deflection of a group of washers comprising the spring-washer element. Specifically, when the spring-washers are used in a stack oriented in the same direction, or a “parallel” orientation, the resultant effect additively increases the stiffness, or force required to flatten or deflect the loading spring, which is equivalent to the rebound force potential spring washers, under load. When used in a stack with alternating orientation, or in a “series” orientation, the force required to the flatten or deflect the loading spring remains approximately the same, while the linear deflection is additively increased.

Spring-washers 29, for use with the loading spring 30, have the ability to be fine-tuned for precisely engineered recoil qualities. Spring-washers, such as used with the present invention, are conventionally employed in machinery applications requiring only small deflections in dampening, as spring-washers have a tendency to “bottom-out,” which means to over-compress and flatten, and develop “hysteresis,” which is a term used by those skilled in mechanical engineering to describe a rebound reducing memory and dynamic fatigue in a particular material or manufactured part. Additionally, spring-washers are typically made from steel, and preferably chemically plated and well lubricated for resistance to corrosion and material degradation, due to friction and wear. Typically, a corrosion resistant treatment for the spring-washers, such as a non-electrolytic nickel or “Kanigen” plating, along with a coating of high-pressure grease is suggested, as is known to those skilled in protective surface treatments for industrial metal parts of this nature.

Preferably, the loading spring 28 is a set of spring-washers 30, uniquely selected and configured to work together as a unit, to counteract the movement or action of the anvil 16, under load from the hammer 17. As discussed above, the alternating parallel and series orientation 54, of several groups of conical washers, abutted end-to-end, are most preferred. However, any configuration of conical spring-washers, singularly, in series, in parallel, or any combination thereof, could be employed for the purposes of the present invention. As detailed in FIG. 4A, three sets of washers in series, with each set comprising four washers, is most preferred. With the first and third set installed in the same orientation, and the middle set stacked opposite orientation, the overall effect provides a strong spring action with the desired compression and recoil distances.

In an alternative embodiment of the loading spring 28 employed in the present invention, a compact compression-spring, such as a helical or coiled spring, an elastomeric dampener, or some such spring as known by those skilled in spring and dampener technology, may be selected to withstand high compressive force and a high number of work cycles, and may be utilized instead of the set of spring-washers 30.

As shown in FIG. 3, the tilt-body 22, which includes the tilt platen mount 36, also includes a hammer mount 41. Preferably, the tilt platen mount is located at a top or “tooling end” 42 of the platen tilt-body. Most preferably, the hammer mount located at a lower or “base end” 43 of platen-tilt body, with the platen hammer 17 received immovably, preferably with a set of hammer screws 44, onto the tilt body at the hammer mount. The hammer is preferably made of a hardened and deformation resistant alloy, such as a high Cr—Mo steel that has been case hardened to a Rockwell Scale hardness in the standardized “HRC” range of forty-five to fifty-five.

The immovable mounting of the platen hammer 17 to the hammer mount 41 on the platen-tilt body 22 can be any means of fastening as typically employed to secure such a member, but fine threaded machine screws for the hammer screws 44 are preferred, allowing the hammer to be removed for replacement, adjustment or repair. However, any conventional mounting method, such as welding, rivets or clamps, if secure and immovable, could also be employed to mount the hammer to the tilt body. Also, alternatively, the platen hammer could be a unitary or “formed” or milled portion of the platen-tilt body.

In operation of the pre-loading mechanism 15, the platen tilt-body 22 rotates to contact the platen hammer 17 with the anvil head 18, of the anvil assembly 16, thereby compressing the loading spring 28 held within the anvil assembly 16. The platen-tilt body momentarily halts its rotation as the loading spring reaches a desired compression, aligning the tilting platen 25 with the receiving platen 33.

After a forced contact or clamping with the receiving platen 33, the tilting platen 25 is driven linearly, away from the receiving platen, by downward action of the tilt frame 21. The platen tilt-body 22 resumes rotation after the tilting platen unclamps and clears the receiving platen, by rotation about the tilt pivot 38 within the tilt frame. This unclamping action of the platens allows the anvil head 18 to rebound as the loading spring 28 extends. The anvil head, which is mounted to the carriage 32, then separates from the platen hammer 17 and the platen tilt-body with tilting platen, rotates away from a linear relation with the receiving platen 33.

The carriage 32 and the tilt frame 21 move in unison as a sliding frame 35, by action of the thermoforming press 10. The carriage and the tilt frame of the sliding frame operate in parallel, as one inter-connected element, and maintain the anvil base 20 mounted to the carriage at precisely the same point relative to the tilt frame, throughout the cyclic operation of the press. By maintaining the anvil base in a precise relation to the tilt frame, the pre-loading mechanism 15 operates with the precision required for accurate pre-loading action, cycle after cycle of the press.

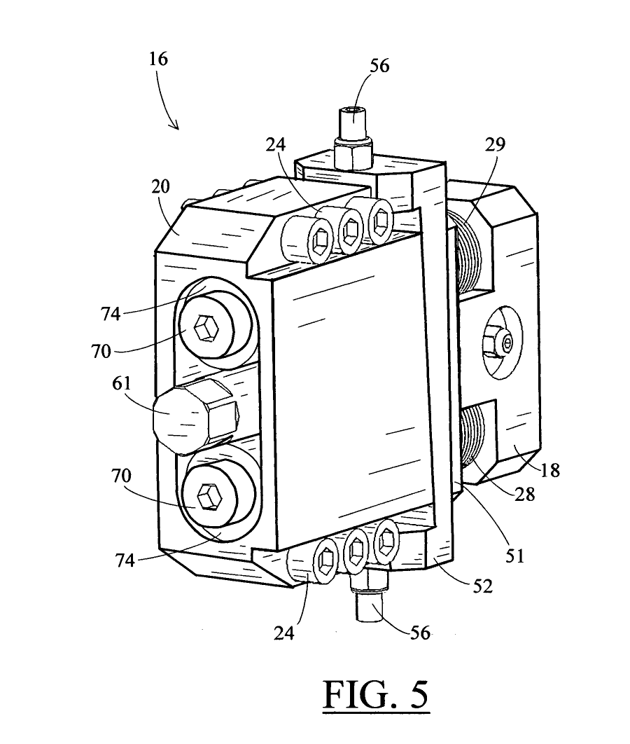

In a preferred, detailed operation of the anvil assembly 16, the loading spring 28 preferably compresses against a spring-plate 51 aided by a loading wedge 52, all held within the anvil assembly 16, as shown in FIG. 5. Specifically, the loading spring is held under tension between the anvil head and the spring plate. The spring plate is most preferably a high strength steel or other alloy, selected to provide a long wearing surface and a firm foundation for the loading spring.

The loading wedge 52 of the anvil assembly 16, as shown in FIG. 4, abuts to the spring plate 51, at the opposite side of the spring plate relative to the loading spring 28. The loading wedge seats upon the anvil base 20, and is slidingly adjustable along the anvil base, able to move substantially perpendicular to the action of the anvil head 18. With the loading wedge positioned between the anvil base and a spring plate, as shown in FIG. 5, and the spring plate abutted to the loading spring, the loading wedge adjustably supports the spring plate.

The loading wedge 52 is easily adjusted, with a “wedge set-screw” 56. Preferably, a pair of wedge set-screws are utilized, with one on each side of the anvil assembly, as shown in FIG. 4. The wedge set-screws drivingly adjust the loading wedge laterally on the anvil base 20, to fix and maintain the position of the loading wedge. With the loading wedge slidably adjustable, the distance between the anvil base and the spring plate 51 is variable, to maintain the loading spring 28 in position, preventing gaps or rattling during press 10 operation. Most preferably, the spring washers 29 are maintained under a slight compressive pretension against the spring plate, again, to prevent mis-alignment movement, and rattling during active cycles of operation.

Additional, and finer tuning of the tension on the loading spring 28 is accomplished by utilizing a pretension adjustment screw 61. As shown in FIG. 4, the pretension adjustment screw preferably includes a plate shoulder 62 that abuts against the spring plate 51, and a set of base threads 63 to engage the anvil base 20. Cranking or driving the pretension adjustment screw centrally forces the spring plate against the loading springs. The spring wedge jams against the remainder of the spring plate, to maintain the desired pretension force uniformly across the spring plate, upon the loading spring.

The pretension adjustment screw 61 also serves to maintain the anvil head 18 in a centered position during action of the anvil assembly 16, as shown in FIG. 4. The pretension adjustment screw extends through the anvil base 20, the loading wedge 52 and the loading spring 28, and into the anvil head, preferably terminating with a pretension screw tip 66 that is received into a pretension screw socket 67, within the anvil head. The anvil head maintains alignment on the anvil body, centered by the pretension screw tip within the pretension screw socket.

Preferably, the purely linear action of the anvil head 18 relative to the anvil base 20 is additionally ensured by a pair of shoulder bolts 70, positioned on each side of the pretension adjustment screw 61, as shown in FIG. 4. Similar to the pretension adjustment screw, the shoulder bolts extend through the anvil base, the loading wedge 52 and the loading spring 28, and into the anvil head. The shoulder bolts preferably terminate with a shoulder tip thread 71 that engages the anvil head. The anvil head includes a threaded shoulder socket 72 for receiving the shoulder tip threads, for each of the shoulder bolts.

Additionally, the shoulder bolts 70 are each dampened by an anvil bushing 74, contained within the anvil base 20, as shown in FIG. 4. Under de-compression of the anvil head 18 into its rest position, at its furthest rebounded position away from the anvil base, the shoulder bolts slide along with the anvil head and the compression of the anvil bushing against the counter pressure of the loading springs 28, maintains a pre-tension against each shoulder bolt.

The pre-loading mechanism 15 insures proper registry of the tilting platen 25 with the receiving 33 platen. Misfed plastic material 35, which may be scrap or non-ejected product 34 can prevent the required registry or mating of the tilting platen with the receiving platen. The pre-loading mechanism helps to prevent misalignment of the platens, especially due to inadvertent materials retained in the path between the platens. With the pre-loading mechanism, the force supplied by the tilt crank arm 39 to rotate tilt-body 22 around the tilt pivot 38 and align the tilt-body with the tilting platen can overcome the possible obstruction or scrap residuals, relying upon the pre-loading mechanism to precisely halt the rotation of the tilt-body, at the predetermined point of rotation for proper registry and clamping of the platens.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

1. A pre-loading mechanism for use with a tilting platen of a thermoformer, the pre-loading mechanism comprising:
an anvil assembly including an anvil base and an anvil, the anvil base immovably mounted to a slidable frame member of the thermoformer, and the anvil maintained separate from the anvil base by a loading spring;
the tilting platen rotatably mounted within the slidable frame member;
a platen hammer immovably mounted to the slidable frame member;
the loading spring compresses and retracts the anvil as the hammer contacts the anvil, and the tilting platen rotates in the slidable frame member to align the tilting platen with a receiving platen;
the slidable frame member movable within the thermoformer, to clamp the tilting platen to the receiving platen; and
the loading spring de-compresses and extends the anvil as the hammer separates from the anvil, and the tilting platen rotates away from the over-platen.

2. The pre-loading mechanism of claim 1, wherein;
the pre-loading spring includes a conical washer, the conical washer resistant to flattening upon compression of the pre-loading spring.

3. The pre-loading mechanism of claim 1, wherein;
the anvil assembly additionally includes a pre-load wedge, the pre-load wedge adjustably positioned between the anvil base and a spring plate, the spring plate abutted to the pre-loading spring; and
the pre-load wedge slidably adjustable to vary the distance between the anvil base and the spring plate.

4. A pre-loading system for use with a thermoforming press, the pre-loading system comprising:
a tilt-body including a tilting platen immovably mounted to the tilt-body, the tilt-body rotate-ably mounted to a tilt-frame, and the tilt-frame mounted to a frame of the thermoforming press;
an anvil assembly including an anvil base and an anvil, the anvil base immovably mounted to a carriage, the carriage mounted to the frame of the thermoforming press, and the carriage movable on the frame in a parallel relation with movement of the tilt-frame within the frame;
the anvil maintained separate from the anvil base by a loading spring;
a platen hammer immovably mounted to the tilt-body;
the loading spring compresses and retracts the anvil as the hammer contacts the anvil, and the tilting platen rotates with the tilt-body to align the tilting platen with a receiving platen; and
the loading spring de-compresses and extends the anvil as the hammer separates from the anvil, and the tilting platen rotates on the tilt-body away from the over-platen.

5. The pre-loading mechanism of claim 4, wherein;
the pre-loading spring includes a conical washer, the conical washer resistant to flattening upon compression of the pre-loading spring.

6. The pre-loading mechanism of claim 4, wherein;
the anvil assembly additionally includes a pre-load wedge, the pre-load wedge adjustably positioned between the anvil base and a spring plate, the spring plate abutted to the pre-loading spring; and
the pre-load wedge slidably adjustable to vary the distance between the anvil base and the spring plate.

7. The pre-loading mechanism of claim 4, wherein;
the carriage and the tilt frame are interconnected as a sliding frame, to co-operate and move in parallel within the frame of the thermoforming press, and to maintain the anvil base in a precise relation to the tilt frame, through cyclic operation of the thermoforming press.
